(19) United States
(12) Patent Application Publication
(10) Pub. No.: US 2009/0024583 A1
(43) Pub. Date: Jan. 22, 2009

(54) TECHNIQUES IN USING FEEDBACK IN CRAWLING WEB CONTENT

(75) Inventors: Amit Jaiswal, Bangalore (IN); Ravikiran Meka, Bangalore (IN); Binu Raj, Bangalore (IN)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc., Sunnyvale, CA (US)

(21) Appl. No.: 11/855,962

(22) Filed: Sep. 14, 2007

(30) Foreign Application Priority Data
Jul. 18, 2007 (IN) 1520/DEL/2007

(51) Int. Cl. G06F 7/06

(52) U.S. Cl. 707/3; 707/E17.108

(57) ABSTRACT

A method for providing feedback to a web crawler is provided. A content processor determines whether a crawled web page is useful to an application. This determination is passed to a learning module. The learning module analyzes crawled web pages and the determinations of usefulness made by the content processor and generates rules for crawling more useful web pages and less non-useful web pages. The learning module provides these rules to the crawler, which applies them in making crawling decisions. Rules expire after a period of time. Paths from a web site's main web page to useful web pages are preserved. A token tree is constructed to facilitate the generation of rules.

### CROSS REFERENCE TO RELATED APPLICATIONS

This application is related to and claims the benefit of priority from Indian Patent Application No. 1520/DEL/2007 filed by Jaiswal et al. in India on Jul. 18, 2007, entitled “Techniques in Using Feedback in Crawling Web Content”; the entire content of which is incorporated by this reference for all purposes as if fully disclosed herein.

### FIELD OF THE INVENTION

The present invention relates to computer networks and, more particularly, to techniques for providing feedback to a web crawler to enhance the quality of crawled content and the crawler's efficiency. BACKGROUND

The Internet is a worldwide system of computer networks and is a public, self-sustaining facility that is accessible to tens of millions of people worldwide. The most widely used part of the Internet is the World Wide Web, often abbreviated “WWW” or simply referred to as “the Web.” The Web organizes information through the use of hypermedia. The HyperText Markup Language (“HTML”) is typically used to specify the contents and format of a hypermedia document (e.g., a web page).

A web page is the image or collection of images that is displayed to a user when the web page's HTML file is rendered by a browser application program. Each web page can contain embedded references to resources such as images, audio, video, documents, or other web pages. On the Web, the most common type of reference used to identify and locate resources is the Uniform Resource Locator, or URL. A user using a web browser can reach resources that are embedded in the web page being browsed by selecting “hyperlinks” or “links” on the web page that identify the resources through the resources' URLs.

Because the Web provides access to millions of pages of information that are often poorly organized, it can be difficult for users to locate particular web pages that contain the information that is of interest to them. To address this problem, a mechanism known as a “search engine” has been developed to index a large number of web pages and to provide an interface that can be used to search the indexed information by entering certain words or phrases (keywords) to be queried. Although there are many popular Internet search engines, they generally include a “web crawler” (also referred to as “crawler”, “spider”, “robot”) that “crawls” across the Internet in a methodical and automated manner to locate Web pages around the world.

There are two common types of “crawling”. In “free crawling,” when a crawler locates a document, the crawler stores the document and the document's URL, and follows any and all links embedded within that document to locate other web pages. In addition, crawler applications may provide located web content to applications which are interested only in web content related to a specific topic, such as job listings. In applications with a topic focus, the crawler applies “focused crawling.” In focused crawling, the crawler tries to crawl only those web pages which contain a specific type of content.

Currently, both types of crawlers suffer from the problem of crawling a large amount of content from web sites that do not contain content of interest. Resources such as storage and bandwidth are expended to fetch, refresh, and store these web pages, which can otherwise be used to crawl new web pages and in refreshing web pages containing content of interest. In focused crawling, one reason for this inefficiency is that it is very difficult for a focused crawler to determine a priori the content of a web page and which web pages will lead to web pages containing content of interest.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram that illustrates an example of a system for providing feedback to a web crawler.

FIG. 2 is a diagram that illustrates an example of a directed graph comprising nodes and edges.

FIG. 3 is a diagram that illustrates another example of a directed graph comprising nodes and edges.

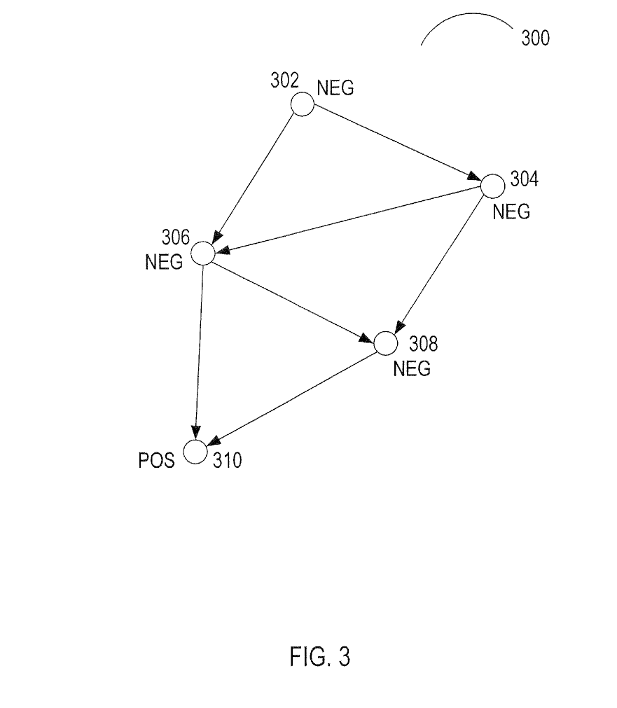

FIG. 4 is a diagram that illustrates another example of a directed graph comprising nodes and edges.

FIG. 5 is a diagram that illustrates another example of a directed graph comprising nodes and edges.

FIG. 6 is a diagram that illustrates another example of a directed graph comprising nodes and edges.

FIG. 7 is a diagram that illustrates an example of a token tree.

FIG. 8 is a block diagram of a computer system on which embodiments of the invention may be implemented.

### OVERVIEW

Techniques are disclosed for providing feedback to a crawler to improve the crawler's efficiency. A crawler crawls a web site to locate and fetch web pages from the web site. The crawler provides the fetched web pages to a content processor, which analyzes the web pages and determines whether a particular web page is “useful.” A web page is “useful” when it is of value to an end application. For example, an end application may be a search engine which needs to maintain a database of current job listings. For this application, a web page may be “useful” if it contains any of a number of job-related keywords. Therefore, the content processor may parse through web pages to determine if a particular web page contains one of the job-related keywords and if so, determine that web page to be useful. The determination of a web page's usefulness by the content processor is then provided as feedback to a learning module. At the learning module, this feedback is analyzed and learning is performed. The learning module then generates a set of rules for locating useful web pages, based on the feedback received from the content processor. These learned rules are provided to the crawler, which applies the rules in determining which web pages to crawl. In sum, the determination by a content processor of whether a web page received from a crawler is useful, based on the needs of an end application which utilizes crawled information, is analyzed and fed back to the crawler in the form of learned rules to enhance the crawler's ability to crawl more useful web pages and less non-useful web pages.

Often, a particular web page can only be reached from another web page, once the particular web page has expired. If the particular web page has been determined to be useful, a crawler may not be able to reach it after expiration to fetch updated content from that web page. Therefore, according to one technique, non-useful web pages which lead to useful web pages are considered “relevant,” and the learning module generates rules to crawl relevant as well as useful pages to ensure that all useful web pages may be reached by the crawler.

In another embodiment, when there are multiple paths of non-useful web pages which reach the same useful web page, at least one path is preserved for crawling. That is, the learning module generates rules to crawl at least one path of relevant web pages.

In yet another embodiment, the learning module generates rules to the crawler which instruct the crawler about the priorities of crawling certain web pages. In other words, the learned rules instruct the crawler to “refresh” (i.e. crawl a previously visited web page to fetch updated content) certain web pages at a higher frequency than other web pages.

Because the Web is dynamic and web pages and web sites are constantly deleted, added, and updated, a crawler may fail to crawl useful web pages if the learned rules are based on old web content that has since changed. Therefore, in one embodiment, each learned rule is associated with a count-down timer so that after a set amount of time, the rule expires and no longer has an effect on the crawler's decisions. As a result, the crawler makes decisions based on only recent and unexpired rules.

Finally, an embodiment is disclosed for segmenting the URLs of web pages to facilitate the generation of rules. This technique involves constructing a “token tree” and is described in detail below.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### System for Providing Feedback to Crawler

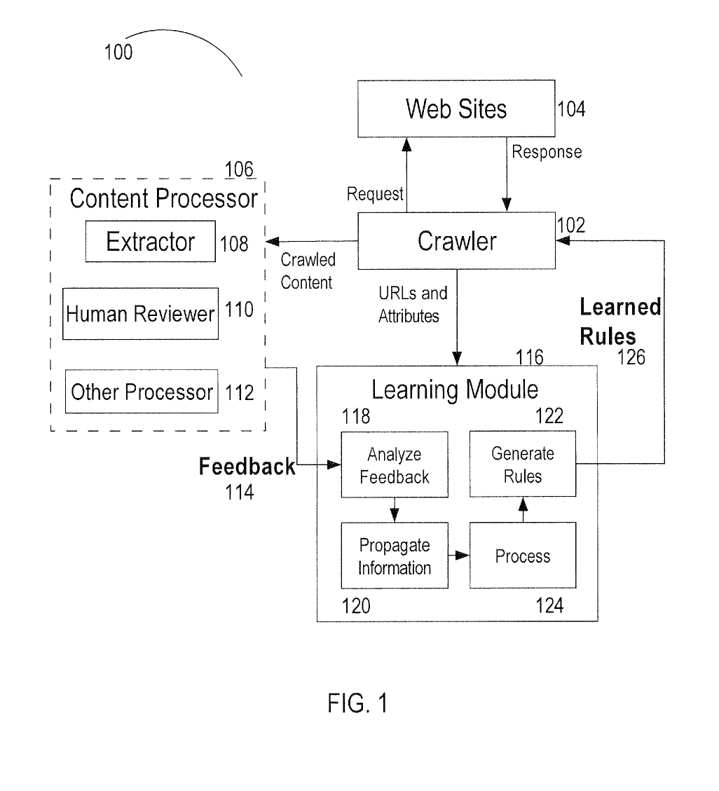

FIG. 1 illustrates an example of a system 100 for providing feedback to a crawler. Crawler 102 interacts with web site 104. Specifically, crawler 102 sends requests for web pages to web site 104, and web site 104 provides the requested web pages in response. Next, crawler 104 provides the crawled content, which includes the contents of the web pages and associated information, to content processor 106. Information associated with a web page includes, among other things, the web page's URL, attributes, and meta-information such as the time at which the web page was downloaded.

The content processor 106 performs the function of determining whether a web page is useful. This determination regarding the usefulness of web pages forms the basis of the feedback that will be provided to the crawler for adjusting the crawler's crawling decisions. Content processor 106 determines whether a particular web page is useful based on the needs of an end application which receives and processes the content fetched by the crawler. For example, if the end application is a search engine for job listings which uses the content fetched by the crawler to maintain a database of current job listings on job-related web sites on the Web, then content processor 106 determines that a web page is useful only if the web page contains job listings which can be used to update the search engine's database. Another example end application may be a repository of scientific articles which posts any new articles related to certain topics of interest. For the remainder of this disclosure, the job listings search engine end application will be used as an example for illustration. However, the techniques discussed herein may similarly be applied to any application with a focus in a specific type of web content.

Content processor 106 may use a variety of methods to determine whether a web page is useful, depending on what is actually useful to a particular end application. FIG. 1 illustrates that content processor 106 may consist of one or more different processing modules for making usefulness determinations.

For some end applications, a web page is useful if it is related to a certain topic. For example, with a job listings search engine, a web page is useful if it is related to the topic of job listings. An extractor 108, which extracts specific types of information from a web page, may be employed to determine if the web page is related to job listings. For example, extractor 108 extracts the title of a web page and determines that the web page is useful only if the words “job” or “jobs” appears in the title. A human reviewer 110 may also be employed to make usefulness determinations. For example, human reviewer 110 may be provided with a group of web pages and be instructed to determine that a web page is useful only if the web page contains at least five job listings. Any other type of decision-making processor 112 may be included in a content processor 106 for determining a web page's usefulness. In this example, a processor 112 may simply be a parser which parses the content on a web page and determines that the web page is useful if it contains at least one of a predefined group of job-related keywords such as “job,” “salary,” and “hiring.”

The content processor 106's determination of the usefulness of web pages is provided as feedback 114 to learning module 116. For example, learning module 116 receives feedback 114 that the web page with URL “A” is useful, while the web page with URL “B” is non-useful. Learning module 116 also receives other information about web pages from crawler 102, such as a web page's inlinks and outlinks. An inlink of a particular web page is a web page which contains a link to the particular web page. An outlink of a particular web page is a web page to which the particular web page links. Importantly, an outlink of a particular web page is a web page which can be reached by any link that can be generated from the particular web page, including links which are dynamically generated such as those generated by execution of a Java script on the particular web page and links which are generated after submitting a form on the particular web page. For example, crawler 102 may inform learning module 116 that the web page with URL “A” is an outlink of the web page with URL “B”, and conversely, that the web page with URL “B” is an inlink of the web page with URL “A”—in other words, that the web page with URL “B” contains a link to the web page with URL “A”.

Learning module 106 analyzes the feedback 114 it receives from content processor 106 in conjunction with the information it receives from crawler 102. Based on this analysis, learning module 106 identifies common features among the web pages which have been determined to be useful, and summarizes these features into learned rules 126. Learning module 106 then provides learned rules 126 to crawler 102. Crawler 102 applies these rules to crawl only web pages which satisfy learned rules 126.

The techniques discussed below describe the operation of the learning module 116 in further detail. However, these techniques are only examples of possible embodiments, and a variety of other techniques may be employed by the learning module 116 to analyze feedback 114 and generate learned rules 126.

### Propagating Feedback

Content on the Web is dynamic and is changing all the time. Therefore, crawler 102 needs to revisit web pages which have been determined to be useful to fetch the most updated content. At the same time, some useful web pages may have expired, and a crawler may only be able to revisit these web pages by following a path of links to the useful web pages. Thus, for each useful web page, there is a need to preserve at least one path of web pages from a web site's “seed page” to the useful web page in the set of web pages that the crawler 102 crawls. A “seed page” is a web page from which a web crawler starts crawling, and can be set manually or determined through another application.

A web page which links directly or indirectly to a useful web page is “relevant.” In one embodiment, the learning module 116 generates learned rules 126 which instruct crawler 102 to crawl both useful and relevant web pages to ensure that all useful web pages can be reached by the crawler from “seed pages”.

In the learning module 116, URLs of web pages are represented as nodes within a graph. A link is represented in the graph by a directed edge wherever one web page contains a link to another web page. A directed edge leads from one node, which represents the web page containing the link, to another node, which represents the web page to which the link refers. Information about how web pages are linked to one another is derived from information about the inlinks and outlinks of a web page that learning module 116 receives from crawler 102.

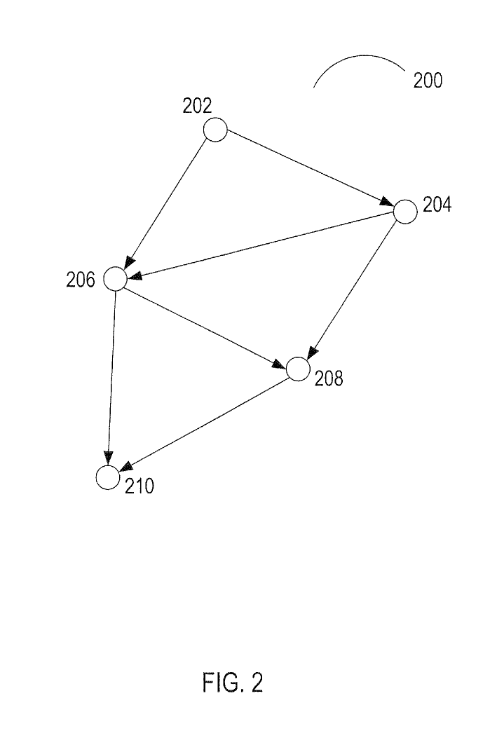

FIG. 2 illustrates an example of a directed graph 200. Nodes 202, 204, 206, 208, and 210 represent URLs, and the edges between them represent links among the URLs. For example, nodes 204 and 206 both contain links to node 208, and node 208 links to node 210. URLs represented by nodes in a directed graph may be augmented with other information such as POST parameters and cookies, so that two web pages fetched with the same base URL but with different POST parameters and cookies will be represented as two separate nodes and may be separately refreshed by a crawler. Learning module 116 may contain a module for analyzing feedback 118, which may perform this augmentation function.

As discussed above, learning module 116 receives feedback 114 regarding whether a web page containing a particular URL is useful. In one embodiment, learning module 116 stores this information in the directed graph. For example, directed graph 300 contains nodes 302, 304, 306, 308, and 310 and their interlinking edges. Learning module receives feedback that of the five nodes in directed graph 300, only node 310 is useful. Consequently, node 310 is marked positive (“POS”) while nodes 302, 304, 306, and 308 are marked negative (“NEG”). These markings represent whether a particular node is useful and is used by the learning module to generate rules for the crawler.

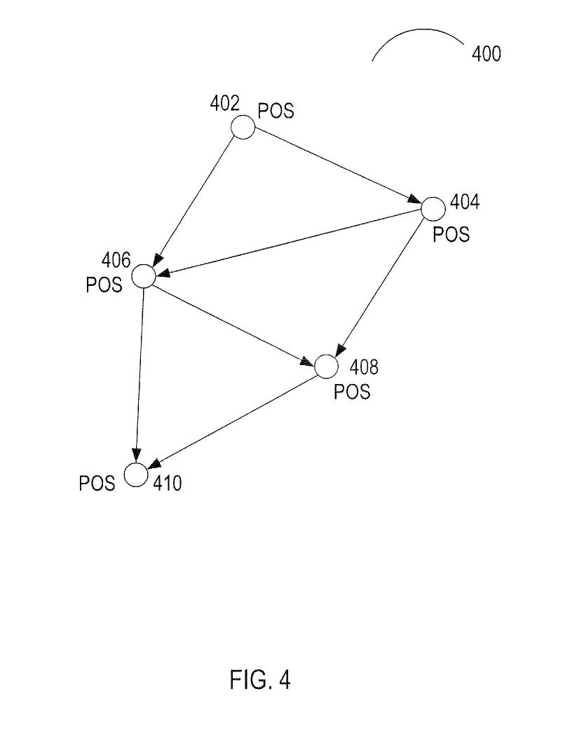

However, a crawler may not be able to reach node 310 after a period of time. Therefore, nodes which are needed to reach node 310 must also be marked positive so that a crawler will also visit them. In one embodiment, any relevant nodes (nodes which link directly or indirectly to useful nodes) are also marked positive. FIG. 4 illustrates an example of a directed graph 400 where useful and relevant nodes are both marked positive. In this example, learning module 116 receives feedback that indicates that only node 410 in directed graph 400 is useful. Node 410 is marked positive. Nodes 402, 404, 406, and 408 are not useful. However, each of these nodes links, either directly or indirectly, to node 410. Therefore, to ensure that node 410 may be reached, nodes 402, 404, 406, and 408 are all marked positive. In other words, node 410's positive mark is propagated “up” through node 410's inlinks. A propagation module 120 in learning module 116 performs this propagation.

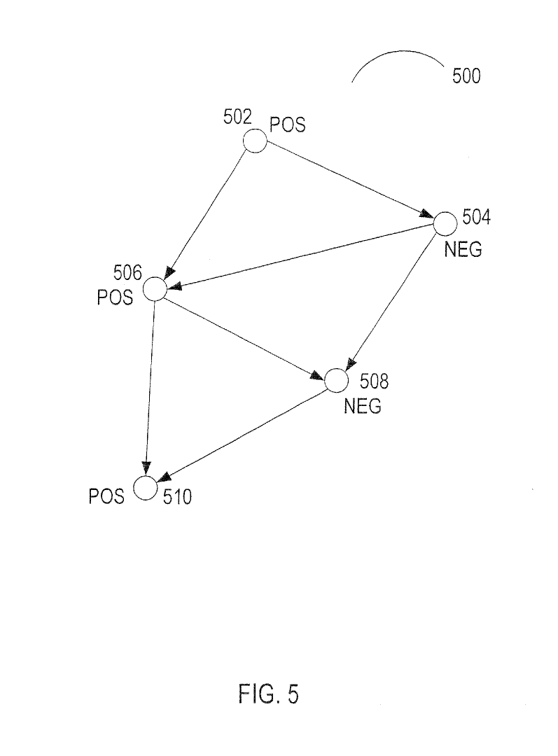

One problem with the directed graph 400 in FIG. 4 is that too many paths to node 410 have been preserved. This results in many relevant nodes being marked positive, which results in the crawler crawling too many non-useful web pages. In one embodiment, all but one path to a useful node are eliminated, thereby reducing the consumption of crawling resources while still preserving a way to reach the useful node. FIG. 5 illustrates a directed graph 500 where only one path to a useful node is preserved. In this example, learning module 116 receives feedback that indicates that only node 510 in directed graph 500 is useful. Node 510 is marked positive. Nodes 502, 504, 506, and 508 are not useful. However, each of these nodes links, either directly or indirectly, to node 510. Instead of marking each of these nodes positive, only nodes for a single path to node 510 are marked positive. Here, nodes 502 and 506 are marked positive, preserving a single path that leads from node 502 to node 510. However, nodes 504 and 508, which are also on paths that lead from node 502 to node 510, are marked negative to save crawler resources. The process module 124 in learning module 116 may perform such “trimming” operations on a directed graph. Trimming to preserve only one single path to a useful node can be done in multiple ways. In one embodiment, the shortest path is preserved. In another embodiment, the path containing the parent nodes is preserved. The “parent node” of a particular node is a node which links to the particular node and which is the first node through which a crawler reached the particular node. For example, when the crawler crawls web page “A”, follows a link on web page “A” to web page “B”, and determines that web page “B” has not been previously discovered, then the node that represents web page “A” is marked as the parent node of the node that represents web page “B”.

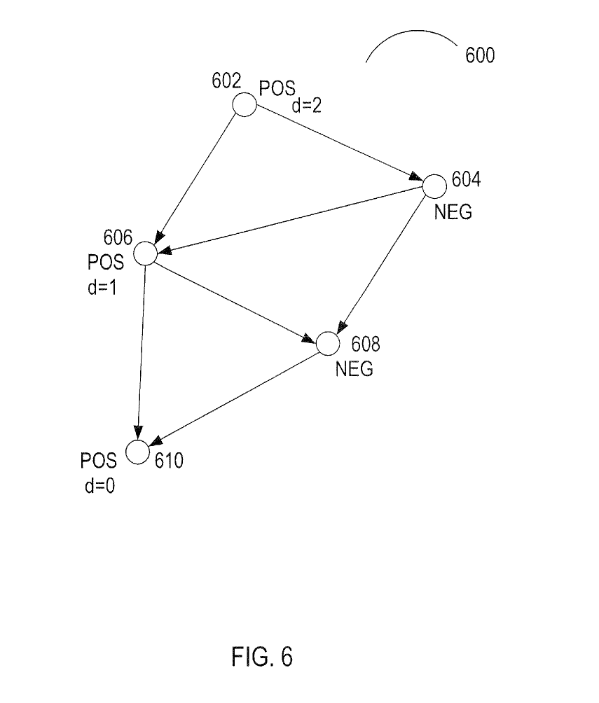

Finally, process module 124 may also mark each positive node with a number representing how far away that positive node is from the useful node. FIG. 6 illustrates an example of a directed graph 600 where the positive nodes have distance markings. Nodes 602, 606, and 610 are positive nodes. Nodes 604 and 606 are negative nodes, and have no distance markings. Node 610 is a useful node. Nodes 602 and 606 are not useful, but are relevant and have been positively marked to preserve a path to node 610. Therefore, node 610, the useful node, is marked with a distance of “0”. Node 606 is one “hop” away from node 610 and is marked with a distance of “1”. Node 602 is two “hops” away from node 610 and is marked with a distance of “2”. These distance markings may be used to set priorities for the crawler so that web pages closer to useful web pages are crawled more frequently.

### Token Tree and Learning

In one embodiment, a “token tree” is built to represent the crawled web pages and the feedback associated with them. A “token tree” provides a structure from which the generating rules module 122 in learning module 116 can easily generate rules.

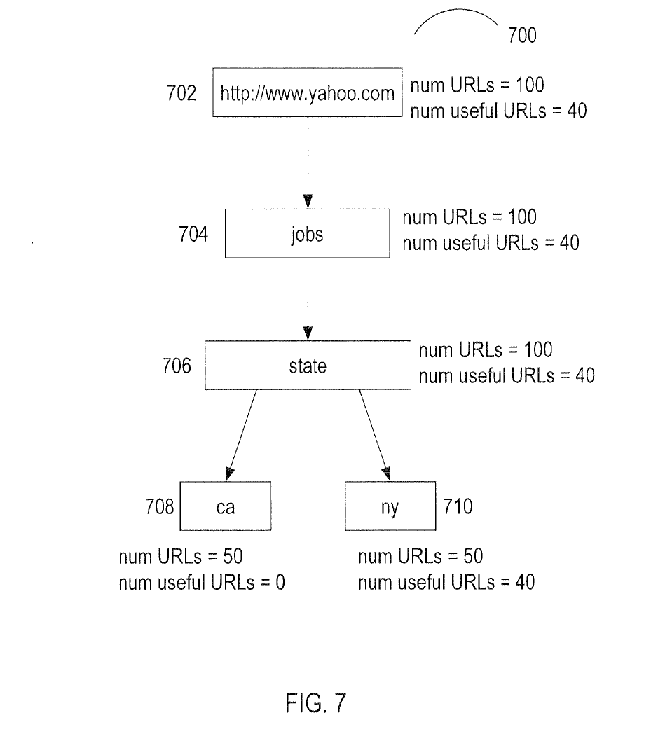

To build a token tree, the learning module 116 separates the different components of a web page's augmented URLs into “tokens” and constructs a token tree from these tokens. For example, the URL “http://www<DOT>yahoo<DOT>com/jobs?state=ca” may be segmented into the tokens: (1) “http://www<DOT>yahoo<DOT>com”; (2) “jobs”; (3) “state”; and (4) “ca”. Similarly, the URL “http://www<DOT>yahoo<DOT>com/jobs?state=ny” may get segmented into the tokens: (1) “http://www<DOT>yahoo<DOT>com”; (2) “jobs”; (3) “state”; and (4) “ny”. After this segmentation, the two URLs discussed in this example may be mapped on a token tree such as the token tree 700 illustrated in FIG. 7. Token tree 700 contains nodes 702, 704, 706, 708, and 710. The learning module determines how to segment a URL and how many tokens, or nodes, to construct.

In one embodiment, a token tree is built to include all the URLs crawled by a crawler, and each crawled URL maps to a unique node in the token tree. For example, the URL “http://www<DOT>yahoo<DOT>com/jobs?state=ca&id=1” maps to node 708 in token tree 700. Multiple URLs may map to the same token. For example, the URLs “http://www<DOT>yahoo<DOT>com/jobs?state=ca&id=2” and “http://www<DOT>yahoo<DOT>com/jobs?state=ca&id=3” also map to node 708 in token tree 700.

Parameters such as the number of URLs that map to a particular node and the number of positive URLs that are mapped to a particular node are also stored at each node in the token tree. Information regarding the number of positive URLs is obtained from the directed graph discussed above by examining whether the URLs which are mapped to a node in the token tree are represented by positively marked nodes in the directed graph. In the example illustrated in FIG. 7, fifty URLs are mapped to node 710, and forty of these URLs are positive. FIG. 7 also indicates fifty URLs are also mapped to node 708 but none of these URLs are positive.

The number of URLs mapped to a parent node in a token tree is the total number of URLs mapped to the child nodes of the parent node. For example, node 706 (“state”) in token tree 700 is a parent node which contains child nodes 708 (“ca”) and 710 (“ny”). Fifty nodes are mapped to both node 708 and node 710. Therefore, there are a total of one-hundred nodes mapped to node 706. Similarly, the number of positive URLs mapped to a parent node is the total number of positive URLs mapped to the child nodes of the parent nodes. Here, no useful URLs are mapped to node 708, but forty positive URLs are mapped to node 710. Therefore, a total of forty positive URLs are mapped to node 706. As the learning module receives more URLs and feedback, the tokens in the token tree are updated to reflect the most current mappings of URLs and useful URLs.

Significantly, the token tree structure is used in conjunction with the directed graph structure discussed above. As described above, the learning module constructs a directed graph where useful URLs are positively marked and where these positive markings are propagated up the directed graph to preserve at least one path to the useful URL. The token tree does not indicate links between URLs. Rather, URLs are tokenized and mapped to a node in the token tree. By storing information about positive markings from the directed graph in the nodes in the token tree, a token tree such as token tree 700 provides an easy way for the learning module to generate rules.

For example, token tree 700 indicates that URLs which contain “http://www<DOT>yahoo<DOT>com/jobs?state=ny” should be crawled, as there is a high probability of crawling a positive page. On the other hand, URLs that contain “http://www<DOT>yahoo<DOT>com/jobs?state=ca” should not be crawled, because there is a very low probability that such URLs are positive pages. The learning module may then generate a rule to crawl URLs which contain “http://www<DOT>yahoo<DOT>com/jobs?state=ny” but not URLs which contain “http://www<DOT>yahoo<DOT>com/jobs?state=ca”, thereby “trimming” the node 708 “branch” of token tree 700.

The learning module may apply a variety of logic in determining how to “trim” a token tree and to generate rules for the crawler. For example, the learning module may set a threshold value so that only nodes which contain useful URLs in excess of the threshold value are crawled. In another example, the learning module may also set priority values for nodes so that URLs which map to nodes which contain a larger fraction of useful URLs are crawled or refreshed at a faster rate than URLs which map to nodes which contain a smaller fraction of useful URLs.

### Expiration of Rules

In one embodiment, rules generated by the learning module are associated with a timer so that each rule expires after a set period of time. When a rule expires, the crawler no longer applies it. The Web is constantly changing, and web pages are frequently added, deleted, and updated. Therefore, applying rules which are based on outdated feedback may decrease the effectiveness of the crawler. By expiring the learned rules, the crawler will only apply the most recent and most updated rules.

### Hardware Overview

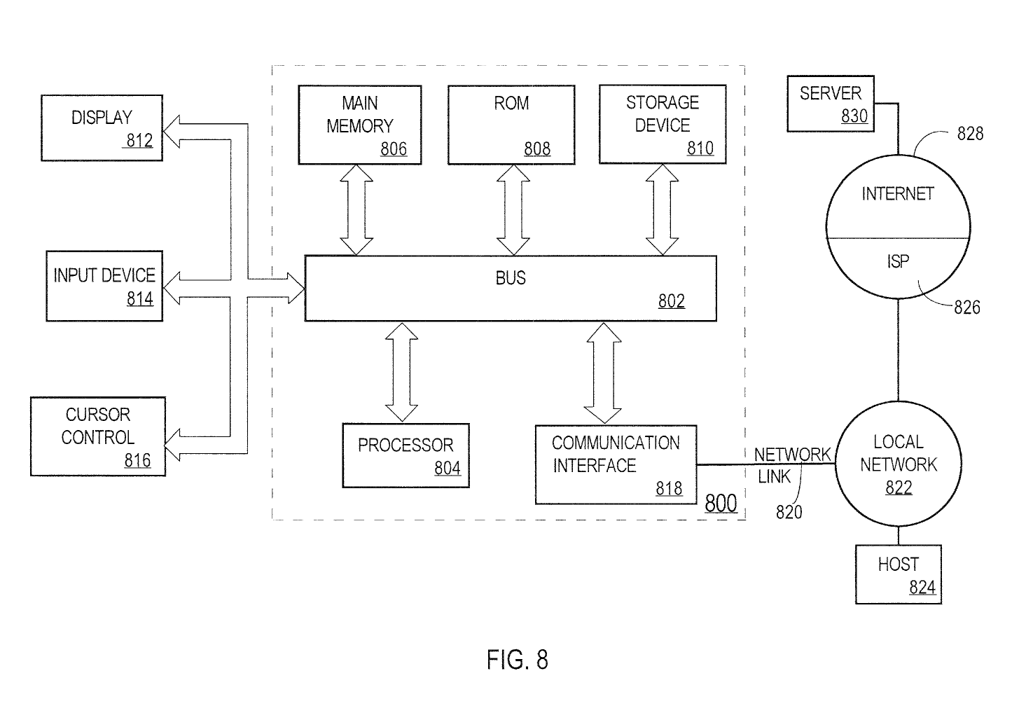

FIG. 8 is a block diagram that illustrates a computer system 800 upon which an embodiment of the invention may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The invention is related to the use of computer system 800 for implementing the techniques described herein. According to one embodiment of the invention, those techniques are performed by computer system 800 in response to processor 804 executing one or more sequences of one or more instructions contained in main memory 806. Such instructions may be read into main memory 806 from another machine-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 800, various machine-readable media are involved, for example, in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution. In this manner, computer system 800 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for using feedback to improve web-crawling, comprising:
receiving, from a web-crawler module, crawled information, wherein the crawled information comprises any combination of URL, contents, attributes, and meta-information of a crawled webpage,
wherein the meta-information comprises inlinks and outlinks of the crawled webpage;
evaluating, based on the crawled information, whether the crawled web page is useful to an application;
generating, based on the crawled information and whether the crawled web page is useful, at least one rule for choosing webpages for crawling;
sending the at least one rule to the web-crawler module;
at the web-crawler module, performing the steps of:
choosing a next webpage based at least in part on the at least one rule; and
crawling the next webpage.

2. The method recited in claim 1, wherein:
the least one rule expires after a period of time; and
the step of choosing a next web page comprises choosing a next webpage based at least in part on the at least one rule if the at least one rule has not expired.

3. The method recited in claim 1, wherein the step of evaluating comprises:
receiving a set of parameters;
determining whether the crawled information satisfies the set of parameters; and
in response to the crawled information satisfying the set of parameters, establishing that the crawled webpage is useful to the application.

4. The method recited in claim 1, wherein the step of evaluating comprises:
receiving, from a human reviewer, input indicating whether the crawled information is useful to the application; and
in response to the input indicating that the crawled information is useful to the application, establishing that the crawled webpage is useful to the application.

5. The method recited in claim 1, further comprising:
updating a directed graph comprising nodes and edges
wherein the nodes represent web pages and the edges indicate links between the web pages; and
wherein the step of updating comprises:
determining if the crawled web page is represented by a node in the directed graph;
in response to determining that the crawled web page is not represented by a node in the directed graph, performing the steps of:
adding to the directed graph a node which represents the crawled webpage; and
for each node representing a web page which links to the node which represents the crawled webpage, adding an edge from the each node to the node which represents the crawled webpage;
marking the node which represents the crawled webpage as negative;
if the crawled web page is useful to the application, marking the node which represents the crawled web page as positive;
wherein the step of generating comprises generating at least one rule to crawl the web pages represented by the positively marked nodes in the directed graph and web pages which are similar to web pages represented by the positively marked nodes in the directed graph.

6. The method recited in claim 5, wherein the step of updating further comprises: for each node in the directed graph:
determining if the each node links to a positively marked node;
determining if the each node is marked negative;
marking the each node positive when the each node links to a positively marked node and is marked negative.

7. The method recited in claim 5, wherein the step of updating further comprises:
for each node in the directed graph:
determining if the each node is a parent node to a positively marked node;
determining if the each node is marked negative;
marking the each node positive when the each node is a parent node to a positively marked node and is marked negative.

8. The method as recited in claim 7, wherein the step of generating comprises:
generating at least one rule to crawl the web pages represented by the positively marked nodes in the directed graph and web pages which are similar to web pages represented by the positively marked nodes in the directed graph wherein the at least one rule further instructs the crawler to crawl web pages which are more closely linked to useful web pages at a higher frequency.

9. The method as recited in claim 7, further comprising:
updating a token tree comprising tokens and token edges wherein:
a token corresponds to a segment of an URL of a web page;
a token edge indicates hierarchy between two tokens in the token tree;
each token in the token tree is associated with a first value representing the number of URLs mapped to the each token and a second value representing the number of positive URLs mapped to the each token;
the step of updating comprises:
based on the URL of the crawled webpage, mapping the URL of the crawled webpage to a mapped token in the token tree;
updating the first value associated with the mapped token;
based on whether the node which represents the crawled web page in the directed graph is positive, updating the second value associated with the mapped token; and
based on the first value and the second value associated with the mapped token, updating the first value and second value associated with all tokens in the token tree which are hierarchically above the mapped token.
wherein the step of generating comprises:
determining, based on the first values and second values associated with the tokens in the token tree, which tokens should be crawled; and
generating at least one rule to crawl web pages with URLs which are mapped to the tokens that should be crawled and web pages similar to web pages with URLs which are mapped to the tokens that should be crawled.

10. The method recited in claim 9, wherein the step of determining which tokens should be crawled comprises determining that a token should be crawled if the second value associated with the token exceeds a threshold value.

11. A computer-implemented computer-readable storage medium storing instructions for using feedback to improve web-crawling, wherein the instructions include instructions which, when executed by one or more processors, cause the one or more processors to perform the steps of:
receiving, from a web-crawler module, crawled information, wherein the crawled information comprises any combination of URL, contents, attributes, and meta-information of a crawled webpage,
wherein the meta-information comprises inlinks and outlinks of the crawled webpage;
evaluating, based on the crawled information, whether the crawled web page is useful to an application;
generating, based on the crawled information and whether the crawled web page is useful, at least one rule for choosing webpages for crawling;
sending the at least one rule to the web-crawler module;
at the web-crawler module, performing the steps of:
choosing a next webpage based at least in part on the at least one rule; and
crawling the next webpage.

12. The computer-readable storage medium of claim 11, wherein:
the least one rule expires after a period of time; and
the step of choosing a next web page comprises choosing a next webpage based at least in part on the at least one rule if the at least one rule has not expired.

13. The computer-readable storage medium of claim 11, wherein the step of evaluating comprises:
receiving a set of parameters;
determining whether the crawled information satisfies the set of parameters; and
in response to the crawled information satisfying the set of parameters, establishing that the crawled webpage is useful to the application.

14. The computer-readable storage medium of claim 11, wherein the step of evaluating comprises:
receiving, from a human reviewer, input indicating whether the crawled information is useful to the application; and
in response to the input indicating that the crawled information is useful to the application, establishing that the crawled webpage is useful to the application.

15. The computer-readable storage medium of claim 11, further comprising:
updating a directed graph comprising nodes and edges
wherein the nodes represent web pages and the edges indicate links between the web pages; and
wherein the step of updating comprises:
determining if the crawled web page is represented by a node in the directed graph;
in response to determining that the crawled web page is not represented by a node in the directed graph, performing the steps of:
adding to the directed graph a node which represents the crawled webpage; and
for each node representing a web page which links to the node which represents the crawled webpage, adding an edge from the each node to the node which represents the crawled webpage;
marking the node which represents the crawled webpage as negative;
if the crawled web page is useful to the application, marking the node which represents the crawled web page as positive;
wherein the step of generating comprises generating at least one rule to crawl the web pages represented by the positively marked nodes in the directed graph and web pages which are similar to web pages represented by the positively marked nodes in the directed graph.

16. The computer-readable storage medium of claim 15, wherein the step of updating further comprises:
for each node in the directed graph:
determining if the each node links to a positively marked node;
determining if the each node is marked negative;
marking the each node positive when the each node links to a positively marked node and is marked negative.

17. The computer-readable storage medium of claim 15, wherein the step of updating further comprises:
for each node in the directed graph:
determining if the each node is a parent node to a positively marked node;
determining if the each node is marked negative;
marking the each node positive when the each node is a parent node to a positively marked node and is marked negative.

18. The computer-readable storage medium of claim 17, wherein the step of generating comprises:
generating at least one rule to crawl the web pages represented by the positively marked nodes in the directed graph and web pages which are similar to web pages represented by the positively marked nodes in the directed graph wherein the at least one rule further instructs the crawler to crawl web pages which are more closely linked to useful web pages at a higher frequency.

19. The computer-readable storage medium of claim 17, further comprising:
updating a token tree comprising tokens and token edges wherein:
a token corresponds to a segment of an URL of a web page;
a token edge indicates hierarchy between two tokens in the token tree;
each token in the token tree is associated with a first value representing the number of URLs mapped to the each token and a second value representing the number of positive URLs mapped to the each token;
the step of updating comprises:
based on the URL of the crawled webpage, mapping the URL of the crawled webpage to a mapped token in the token tree;
updating the first value associated with the mapped token;
based on whether the node which represents the crawled web page in the directed graph is positive, updating the second value associated with the mapped token; and
based on the first value and the second value associated with the mapped token, updating the first value and second value associated with all tokens in the token tree which are hierarchically above the mapped token.
wherein the step of generating comprises:
determining, based on the first values and second values associated with the tokens in the token tree, which tokens should be crawled; and
generating at least one rule to crawl web pages with URLs which are mapped to the tokens that should be crawled and web pages similar to web pages with URLs which are mapped to the tokens that should be crawled.

20. The computer-readable storage medium of claim 19, wherein the step of determining which tokens should be crawled comprises determining that a token should be crawled if the second value associated with the token exceeds a threshold value.
